(19) United States
(12) Patent Application Publication
(10) Pub. No.: US 2017/0351254 A1
(43) Pub. Date: Dec. 7, 2017

(54) UNMANNED AERIAL VEHICLE CONTROL SYSTEM

(71) Applicants: Hunter Arey LISTWIN, Woodside, CA (US); Peter Callender GISH, Woodside, CA (US)

(72) Inventors: Hunter Arey LISTWIN, Woodside, CA (US); Peter Callender GISH, Woodside, CA (US)

(21) Appl. No.: 15/611,415

(22) Filed: Jun. 1, 2017

Related U.S. Application Data
(60) Provisional application No. 62/346,748, filed on Jun. 7, 2016.

(51) Int. Cl. G05D 1/00; H04B 7/185; B64C 39/02; G05D 1/10; H04W 84/04

(52) U.S. Cl. CPC G05D 1/0022; G05D 1/0016; B64C 39/024; G05D 1/101; H04B 7/18506; B64C 2201/146; B64C 2201/141; H04W 84/042

(57) ABSTRACT

An unmanned aerial vehicle control (UAV) system capable of switching between a point-to-point radio frequency connection and a cellular data network connection is provided. The UAV system includes a base unit controller and a UAV. The UAV includes a processing unit, an autopilot, and a signal strength determining apparatus. The signal strength determining apparatus estimates the signal strength between the UAV and the base unit controller, and the signal strength between the UAV and the cellular data network.

### CROSS REFERENCE

This application relates to and claims priority from U.S. provisional application 62/346,748 filed on 7 Jun. 2016, the entirety of which is hereby incorporated by reference.

### FIELD

The present disclosure relates to a system for controlling an unmanned aerial vehicle control system.

### BACKGROUND

Unmanned aerial vehicles (UAVs), unmanned aerial systems (UAS) and drones are all autonomous or remotely piloted aircraft that do not carry a human operator. Despite regulatory and technical challenges, the demand for drones in various industries continues to grow. Broadly speaking, drones may be categorized into the market segments of consumer/hobbyist, commercial, and military.

As set forth below, one or more exemplary aspects of the present embodiments may overcome shortcomings and/or otherwise impart innovative aspects by, for example, providing a drone control system providing improved control, range and functionality at a cost suitable for non-military applications.

### SUMMARY

One object of the present embodiments is to provide an unmanned aerial vehicle control system capable of switching between a point-to-point radio frequency connection and a cellular data network connection. The unmanned aerial vehicle control system includes a base unit controller; and an unmanned aerial vehicle that includes a processing unit, an autopilot, and a signal strength determining apparatus. The signal strength determining apparatus is configured for estimating the signal strength between the unmanned aerial vehicle and the base unit controller, and the signal strength between the unmanned aerial vehicle and the cellular data network.

According to some embodiments alternatively or additionally, the control system uses the point-to-point radio frequency connection when the signal strength between the unmanned aerial vehicle and the base unit controller is at or below a predetermined signal strength.

According to some embodiments alternatively or additionally, the control system uses the cellular data network connection when the signal strength between the unmanned aerial vehicle and the base unit controller is above a predetermined signal strength.

According to some embodiments alternatively or additionally, the control system uses the point-to-point radio frequency connection when the signal strength between the unmanned aerial vehicle and the base unit controller is at or below a predetermined signal strength; and the control system uses the cellular data network connection when the signal strength between the unmanned aerial vehicle and the base unit controller is above a predetermined signal strength.

According to some embodiments alternatively or additionally, the autopilot operates according to a set of predetermined behavior fail-safes when the unmanned aerial vehicle loses both the point-to-point radio frequency connection and the cellular data network connection.

According to some embodiments alternatively or additionally, the set of predetermined behavior fail-safes consists of continue mission, return home, return to place of last known signal, continue to a network hotspot, go to a pre-determined location, loiter, circle, hover, land, lower altitude, ascend, follow geographic contours or other sensor data, and combinations thereof.

According to some embodiments alternatively or additionally, the base unit controller includes a server and an apparatus. The apparatus can be a smartphone, a personal digital assistant, a tablet, a laptop computer or a desktop computer.

According to some embodiments alternatively or additionally, the cellular data network includes 3G, 4G, Long Term Evolution (LTE), Code Division Multiple Access (CDMA), and/or Global System for Mobile communications (GSM) networks.

Another object of the present embodiments alternatively or additionally, is to provide an unmanned aerial vehicle control system for fire detection. The unmanned aerial vehicle control system includes a base unit controller; and an unmanned aerial vehicle that includes a processing unit, an autopilot, and a thermal imaging sensor. The base controller and unmanned aerial vehicle connect with each other using a cellular data network connection. The thermal imaging sensor is configured for detecting fire.

According to some embodiments alternatively or additionally, the base unit controller includes a server and an apparatus. The apparatus can be a smartphone, a personal digital assistant, a tablet, a laptop computer or a desktop computer.

According to some embodiments alternatively or additionally, the cellular data network includes 3G, 4G, Long Term Evolution (LTE), Code Division Multiple Access (CDMA), and/or Global System for Mobile communications (GSM) networks.

Another object of the present disclosures, additionally or alternatively, is to provide an unmanned aerial vehicle control system for maximizing cellular data network coverage. The unmanned aerial vehicle control system includes a base unit controller; and an unmanned aerial vehicle that includes a processing unit, an autopilot configured for storing and utilizing and accessing cellular data network coverage maps, and a location determining apparatus for estimating the distance and position of the unmanned aerial vehicle from the nearest point on a cellular data network coverage map.

According to some embodiments alternatively or additionally, the unmanned aerial vehicle control system flies to a predetermined or real-time processed destination using the shortest distance that comprises points on the cellular data network coverage map.

According to another embodiment, the cellular data network coverage maps comprise 3G and/or 4G maps.

According to another embodiment, the 3G and/or 4G maps are publicly accessible maps from AT&T, Verizon, Sprint and/or T-Mobile.

According to some embodiments alternatively or additionally, the autopilot operates according to a set of predetermined behavior fail-safes when the unmanned aerial vehicle is outside of the cellular data network coverage maps.

According to some embodiments alternatively or additionally, the set of predetermined behavior fail-safes consists of continue mission, return home, return to place of last known signal, continue to a network hotspot, go to a pre-determined location, loiter, circle, hover, land, lower altitude, follow geographic contours and combinations thereof.

According to some embodiments alternatively or additionally, the base unit controller includes a server and an apparatus. The apparatus can be a smartphone, a personal digital assistant, a tablet, a laptop computer or a desktop computer.

### BRIEF DESCRIPTION OF THE DRAWINGS

FIG. 1 illustrates an example UAV control system, according to some embodiments described herein.

FIG. 2A illustrates an example showing UAV flight characteristics, according to some embodiments described herein.

FIG. 2B illustrates another example showing UAV flight characteristics, according to some embodiments described herein.

FIG. 3 illustrates an example flow chart of flight data, according to some embodiments described herein.

FIG. 4 illustrates another example flow chart of flight data, according to some embodiments described herein.

FIG. 5 illustrates an example network diagram, according to some embodiments described herein.

FIG. 6 illustrates example computer components which may be utilized according to some embodiments described herein.

### DETAILED DESCRIPTION

In the following description, various embodiments of the present embodiments are described. For purposes of explanation, specific configurations and details are set forth in order to provide a thorough understanding of the embodiments. However, it will also be apparent to one skilled in the art that the present embodiments may be practiced without the specific details. Furthermore, well-known features may be omitted or simplified in order not to obscure the embodiment being described.

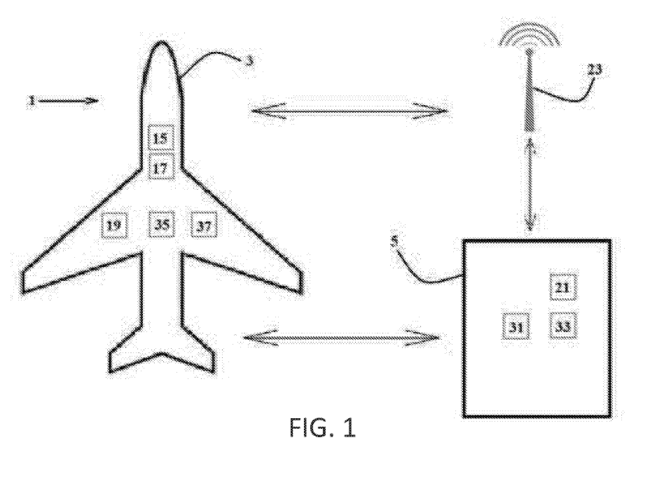

FIG. 1 illustrates the unmanned aerial vehicle (UAV) control system 1. The UAV may be any kind of flight capable vehicle generally falling into a category of an airplane, a helicopter, a drone of any type. The propulsion systems of such UAV could be propeller driven, jet propulsion, rocket, or other kind of aerial propulsion. Such a UAV may have any number of typical flight control surfaces such as ailerons, elevators, rudders, and any combination of then to control flight of the UAV. It should be noted that the terms UAV and drone may be used interchangeably in this description.

The UAV control system in the example of FIG. 1 includes a UAV 3 itself in communication with a base controller 5. The UAV control system is capable of switching between a point-to-point radio frequency connection 21 and a data network connection 23. Such a data network connection may be a cellular connection, or other radio communication system on another band than cellular transmissions. Any radio band could be used to communication between a base station 5 and the UAV 3. The example UAV includes a processing unit 15, an autopilot 17, and a signal strength determining apparatus 19. In some embodiments, the base controller can also include a server 31 and an apparatus 33 that may be a smartphone, a personal digital assistant, a tablet, a laptop computer or a desktop computer as described below. In other embodiments, the UAV may include any number of sensors 35 such as for example but not limited to a thermal imaging sensor and/or a location determining apparatus 37.

The denotation of a drone is an unmanned aircraft or ship that can navigate autonomously at times without human control or beyond line of sight. The level of autonomous travel may differ from example to example, and can be customized for various uses. For example, takeoff and landing may be manually controlled, but mid flight operations may be automated. In some examples, a human controller may take over during the operation aspects and then flight resumes as automated after the operation is complete.

These examples are not limited to flying systems and applies to platforms beyond Unmanned Aerial Systems (UASs) such as boats, rovers, buggies, helicopters, multi copters, submarines, etc. Consumer level drones are relatively inexpensive and simple to operate, but provide limited functionality and flexibility. At a minimum, a transmitter operated by a user transmits direct flight control commands via point-to-point radio transmissions for the drone to execute. As entry-level drones become more sophisticated, they may begin to transmit/receive telemetry data to/from an autopilot unit or flight control board of the drone. The telemetry data may include data including drone orientation, speed, coordinates, acceleration, etc. Once the drone receives the telemetry data, the autopilot unit may determine control of the drone to operate according to the telemetry data. The autopilot may then calculate a flight path that will conform to the received telemetry data inputted by a user based on sensor data taken from the drone.

For example, the telemetry data may include waypoint data to command a drone to hover in place at a predetermined altitude. However, the autopilot may need to compensate for windy conditions in order to maintain a fixed position. Therefore, an autopilot determines how to operate a drone based on a given a set of coordinates and sensor data. Conventional drones operate by point-to-point radio communication and have limited range, which hinder their wider adoption and limits their usefulness. For instance, control may generally be line-of-sight because obstructions such as trees and buildings prevent radio communication between the transmitter and drone. The loss of connectivity between a user and drone may result in loss of the drone and even collateral damage. One advantage of the present embodiments include connectivity can be maintained when radio communication is disrupted. This advantage is achieved by the present embodiments' ability to switch over to a cellular data network.

Commercial drones include additional capabilities and may be deployed for specialized applications, but operate fundamentally in the same way as hobbyist drones. Commercial drones differ in that they are more expensive due to their use of more sophisticated components, additional sensors such as cameras, and enhanced programming and processing capabilities that allow more advanced flight controls. Commercial drones are also limited by short range, point-to-point radio communication, even if they are more powerful than consumer level drones.

Military drones have fewer cost constraints and are designed to maximize range and performance. Military drones also rely on radio communications where available in order to utilize faster data transfer speeds, but are capable of switching to satellite communication systems to provide control of a drone from any location on earth. Of course, military drones are inaccessible to the general public and are cost-prohibitive in their own right.

Commercial Off The Shelf (COTS) technology has not been available for hobbyist and smaller budget drone manufacturers and users until now. Thus, certain example embodiments here include COTS technology for drone communication, piloting, auto piloting, information gathering and sharing, data collection, and/or coordination.

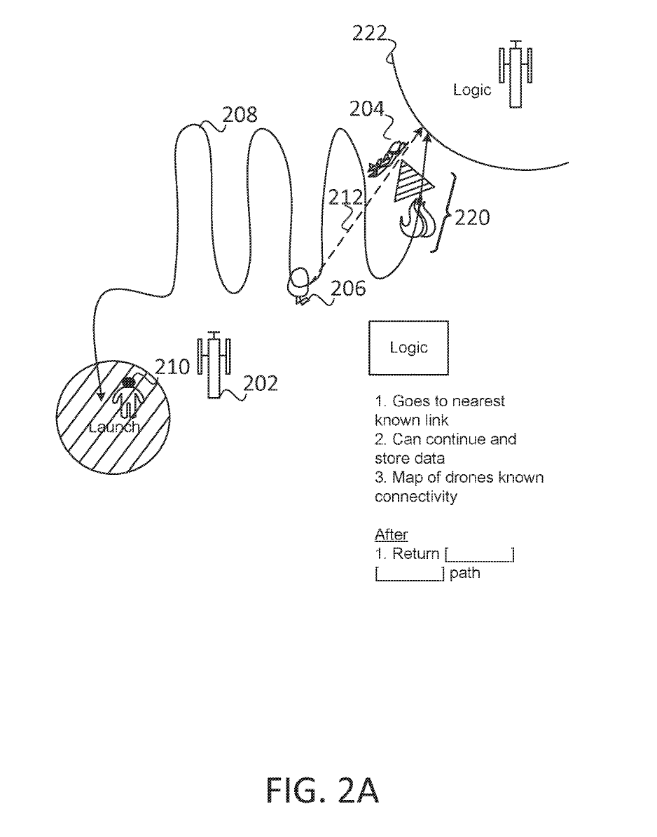

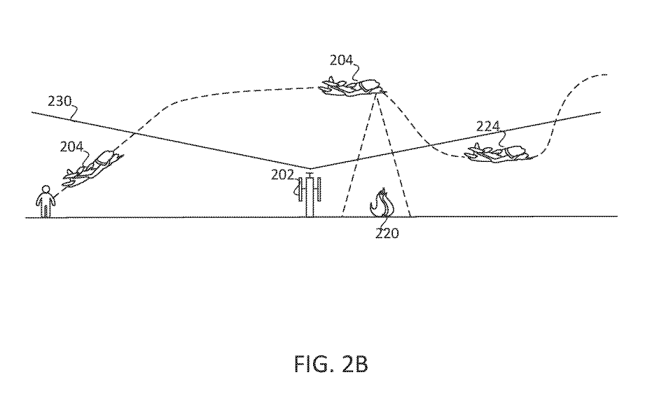

FIG. 2A show examples of another object of the present disclosures, additionally or alternatively, is to provide an unmanned aerial vehicle control system for maximizing cellular data network coverage. The unmanned aerial vehicle control system includes a base unit controller 202; and an unmanned aerial vehicle 204 that includes a processing unit, an autopilot configured for storing and utilizing and accessing cellular data network coverage maps, and a location determining apparatus for estimating the distance and position of the unmanned aerial vehicle from the nearest point 206 on a cellular data network coverage map.

The following examples are merely intended as examples of how the UAV control system can work and are in no way intended to limit the embodiments. The UAV can follow a preprogrammed flight course 208 when desired. A person 210 can intervene as necessary in this preprogrammed course 208. When this occurs, the UAV 204 may deviate from the predetermined course 208 and continues its flight along a remotely-controlled flight path 212 according to transmitted control signals or commands from the base unit controller 202. In this situation, the flight is dependent on the availability of the radio frequency connection and/or cellular data network connection. Should the connections between the base unit controller and the UAV fail because of interference, then the embodiments provide that the flight, which is threatening to become uncontrolled, is continued with a substitute flight program that is generated by the autopilot, after the interruption has been recognized. The substitute flight program guides the UAV through the danger zone 220 until it enters an area in which there is once again contact 222 and it is again possible to guide the UAV 204 with remote control. If such an area of re-established contact cannot be reached, then an automatic return flight to a predetermined landing strip shall be carried out, after a corresponding flight program has been recalculated by the autopilot.

The autopilot can contain a conventional terrain databank, with the help of which the UAV orients itself during automatic flight over the terrain. During flight, the autopilot uses the data in this databank to monitor continuously or in intervals the guidance commands of the base unit controller with respect to maintaining minimum altitudes and minimum distances from obstacles in order to avoid collisions. The autopilot does this by extrapolating the instantaneous flight path, based on the guidance commands, and comparing it with the data in the terrain databank. Dangerous situations are immediately reported and displayed, or an anti-collision program is calculated on-board and suitable correction maneuvers are automatically executed.

If a transition point to return to the remote control is not found, or if it is no longer of interest to continue the remotely-controlled flight, a route will be calculated with the autopilot to return the UAV to a planned target area.

In addition to the above safety features, the autopilot operates according to a set of predetermined behavior fail-safes when the unmanned aerial vehicle loses both the point-to-point radio frequency connection and the cellular data network connection. FIG. 2B shows an example of when the UAV 204 falls loses contact with a base station 202, in this case, dropping below 224 an area where a signal 230 is found. These predetermined behavior fail-safes include continuing mission, returning home, returning to place of last known signal, continuing to a network hotspot, going to a pre-determined location, loitering, circling, hovering, landing, lowering altitude, following geographic contours and combinations thereof.

The signal strength determining apparatus estimates the signal strength. Signal strength can be estimated in a variety of ways operating in a UMTS (Universal Mobile Telecommunications System) system. Received Signal Strength Indicator (RSSI), Received Signal Code Power (RSCP) and Ec/No are among the measurables that can be used as a basis for determining signal strength. The UAV control system can choose between a point-to-point radio frequency connection and a cellular data network connection. The decision on which connection is used is based upon the signal strength between the UAV and the base unit controller. When the signal strength is relatively strong (i.e., above a predetermined signal strength), the point-to-point radio frequency is used. When the signal strength is relatively weak (i.e., below a predetermined signal strength), the cellular data network connection is used.

The cellular networks used in the present embodiments can include, for example, 3G, 4G, 4G Long Term Evolution (LTE), Global System for Mobile Communications (GSM), Evolution-Data Optimized (EV-DO), Enhanced Data Rates for GSM Evolution (EDGE), General Packet Radio Service (GPRS), cdmaOne, CDMA2000, Digital Enhanced Cordless Telecommunications (DECT), Universal Mobile Telecommunications System (UMTS), Digital AMPS (IS-136/TDMA), and Integrated Digital Enhanced Network (iDEN).

A thermal imaging sensor can mean any kind of multi-pixel sensor capable of forming a thermal signature or image within a detection field of the sensor. FIG. 2B again shows a thermal imaging situation with the UAV 202 over a fire 220. This can include all types of infra-red sensor technologies such as thermophiles, bolometers and pyro-electric devices, and in any arrangement of two or more independent pixels to form a representation of the infra-red radiation level within the sensed area, and thereby infer the presence, location, position, speed and direction of movement, temperature and size of any warm or hot objects which naturally radiate long-wavelength (8-12 μm) infra-red radiation, within the sensing area.

The thermal imaging sensor may be utilized to provide remote monitoring of regions to detect a fire and to provide an alarm (e.g., an audible alarm, an email alert, a text message) to notify appropriate personnel and/or systems. For example, the thermal imaging sensor may be used to detect a fire or, for a recently extinguished fire, to detect if temperatures are beginning to increase or the potential risk for the fire to restart (e.g., to rekindle) is increasing and reaches a certain threshold (e.g., a predetermined temperature threshold). In such an application, the thermal imaging sensor may provide an alarm to notify the fire department, or other desired personnel. The thermal infrared cameras may provide thermal image data, which could be provided (e.g., sent via a wired or wireless communication link) to a fire station for personnel to monitor to detect a fire or potential of a fire (e.g., based on images and temperature readings of surfaces of regions). The thermal imaging sensor may also provide an alarm if certain thermal conditions based on the temperature measurements are determined to be present for a region.

The present embodiments are particularly effective for fire watching applications. For instance, a drone may follow a predetermined route over a fire susceptible area. If a thermal imaging camera detects a fire, the data may be transmitted back to a fire department. In particular, a drone launch is initially within a communication coverage range of a base station. However, after reaching a predetermined altitude, the drone may be above the coverage area of the base station but at the appropriate altitude for obtaining sensor readings such as thermal readings that monitor for fire. When not within communication range of the user, the drone will operate autonomously according to a predetermined flight path and behaviors. According to predetermined sensor thresholds, once a fire is detected by the drone at a certain altitude, the drone may resurface in order to reconnect to a broadband connection with the base station to transmit the sensor data to a controller (e.g., an apparatus such as a computer), before returning to the higher altitude and/or continuing along its flight plan. The increased coverage and improved autonomous capabilities of a drone reduces fire detection and response times and reduces the need for human firewatchers or civilians to detect fires.

The drone may include network coverage maps that provide three-dimensional data regarding WiFi and broadband network coverage. This data may be integrated into autopilot or stored in the controller or a cloud as needed. Cell coverage data may include locations of the physical tower, as well as strength information of where the network signals are strong and weak. This may allow the drone to determine a route that maintains a desired level of connectivity. Furthermore, signal strength may be gathered by the drone in real-time since signal strength may differ based on weather conditions. The drone may also utilize information uploaded or gathered by a drone in previous flights or acquired from a controller or the cloud.

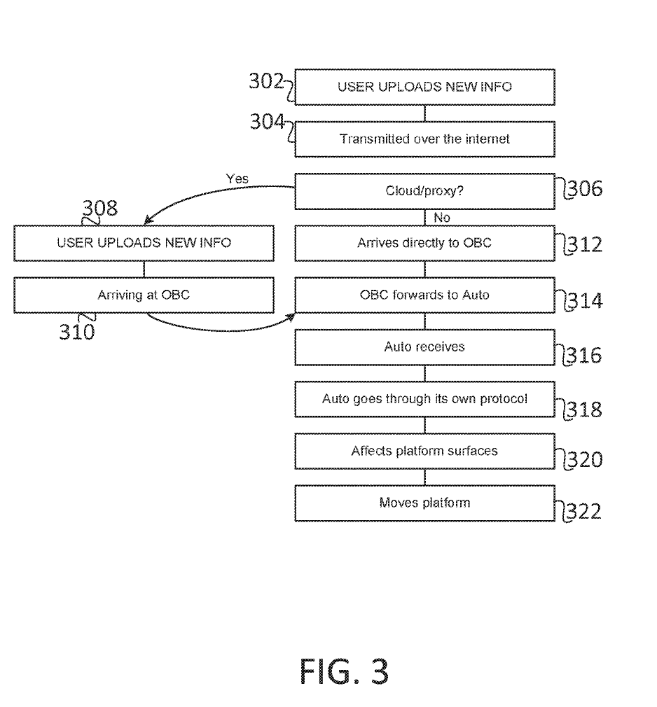

FIG. 3 shows an example flow chart of a user uploading new information 302. Then the information is transmitted over the internet 304 then if the cloud or proxy 306 is used the user may upload new information 308 which can arrive in the onboard computer (OBC) 310. If no cloud/proxy 306, the information may arrive directly to the OBC 312. The OBC may forward the information to the autopilot 314. The autopilot system receives the information 316 then goes through its own protocol 318. Finally, the physical platform surfaces, or flight control surfaces are affected 320 and the entire UAV flight path is affected 322.

The autopilot may generate a flight plan and determine autonomous behavior based on coverage maps, so as to provide a set of waypoints between a starting point and destination that ensure a constant network connection. Primary and backup processing systems may also be provided to ensure that failure of one component does not result in loss of the drone.

The location determining apparatus may be any receiver for receiving location signals and determining a location. For example, the location determining apparatus may include a GPS receiver for receiving GPS location signals and determining a location. Location data may also be calculated using WiFi triangulation, RFID tag positioning and hardwired/physically placed network equipment. In various embodiments, the location determining apparatus may be integrated with a compass module and a UAV navigation system. Alternatively, a processor and, memory may perform navigation based on data received from the location determining apparatus. The location determining apparatus may receive navigation path information stored in memory or navigation path information provided wirelessly.

The UAV may determine its own location based on WiFi signals. The UAV may compare the signal strength of one or more WiFi access points with known locations. The signal strength may be indicative of the distance between the UAV and a WiFi access point. If a plurality of WiFi access points with known locations are present, the UAV may be able to accurately triangulate its location based on only the WiFi signals. The UAV may also use the WiFi location data along with GPS and/or tag data to triangulate its position, creating a dataset of location environment that synthesizes data from these various sensors to establish a method of relative navigation.

In an embodiment where the base controller includes a computer, the computer may also include a display and input device such as a keyboard, mouse, touchscreen, joystick, video game controller, etc. The computer may also be connected via a wired or wireless connection to another device a direct connection or the internet. One computer may receive telemetry data from a second computer to forward to an autopilot in order to augment the protocols of the vehicle or alter the vehicle's mission. The computers may be connected to each other via connection modules and other features that are well known to one of ordinary skill in the art. The connection module may have one or more of the following types of connection abilities: Broadband cellular such as 4G LTE, point to point radio, WiFi, Bluetooth, etc. One computer may forward telemetry data to the autopilot sent to it from a second computer serving as a proxy. If the two computers are connected to each other using the internet, via 4G LTE for example, the computers are no longer tethered by the range of traditional point-to-point radios. The communication link between computers may include multiple types of links including WiFi, 4G and any combination thereof, for example. A combination of communication links may also include direct RF and cellular data connections for data transmission. Communication including telemetry data may be transmitted via one or more proxy servers. Telemetry data may include waypoints, flight controls, and flight data including speed, altitude, etc., and may be modified before and during operation. Protocols for telemetry data include Micro Air Vehicle Link (MAVLink). Telemetry data may be used by an autopilot to determine a stable, obstacle-free flight path that maximizes connectivity.

In some embodiments, the computers may switch a communication method based on signal strength, cost and communication speed. For instance, when a WiFi network is detected, the computer may utilize the WiFi network. Such a switch may be planned, if an area is known to have either strong or weak signal coverage, or could be automatically adjusted in real time by the system or manual adjustment. For example, a drone operating over an area with strong LTE coverage drops into an area which is surrounded by trees, but happens to have good radio connectivity. The system senses the drop off in LTE and increase in radio so it switches primary connectivity to radio.

When the UAV control system loses external communications for a predetermined amount of time, the autopilot may operate according to a set of predetermined behavior fail-safes including continue mission, return home, return to place of last known signal, continue to network hotspot, go to pre-determined location, loiter, circle, hover, land, resurface (lower altitude), follow geographic contours, etc., and combinations thereof. For example, if system is unable to transmit or receive data from the ground station, the cloud, another drone, etc. for a set amount of time, it determines that it has lost connection. With this established, the system defaults to a predetermined setting such as returning to its last known connection location. If connection is still not regained, system may return to home because of programmed settings.

The UAV control system may comprise one or more processing units that may include a removable unit that plugs into and augments the capabilities of an onboard drone-processing unit. The removable autopilot may preform simply as a proxy and relinquish flight processing to a portable computer such as a Raspberry Pi. The removable autopilot may be connected to a first processing unit by a wired or wireless connection where some or all communication data may be processed. The unit responsible for flight data processing may alter telemetry data including waypoints and other autopilot parameters. The autopilot includes a set of predetermined flight plans as well as programming to compensate for interference including turbulence and obstacles. Providing a plurality of autopilot units may allow a conventional drone to be augmented to increase its capabilities, and also provides a cost-effective and simple upgrade path.

The autopilot may be programmed to determine corrections to control surfaces to stabilize any disturbances encountered. The autopilot may provide sustained mission execution without external input. Connected to control surfaces, such as throttle, adjustments are made using sensor data including gyroscopes, accelerometers, GPS, speed, etc. Before or mid operation, an autopilot may be preprogrammed with settings and mission plans.

The autopilot may also receive data from a plurality of sensors located on the drone or provided elsewhere. For example, the UAV control system may include a thermal camera, infrared camera, gyroscope, audio sensor, video camera, proximity sensor, altimeter, accelerometer, etc. Sensor data may include altitude, longitude, latitude, wind speed, speed over ground, air temperature, proximity to objects, signal strength, battery voltage, battery amperage, light intensity, sound intensity, air pressure and so forth. Sensor data, such as weather data, air traffic data, cell signal strength and so forth may be provided to and/or collected by the UAV control system. Decisions can then be made based upon this sensor data.

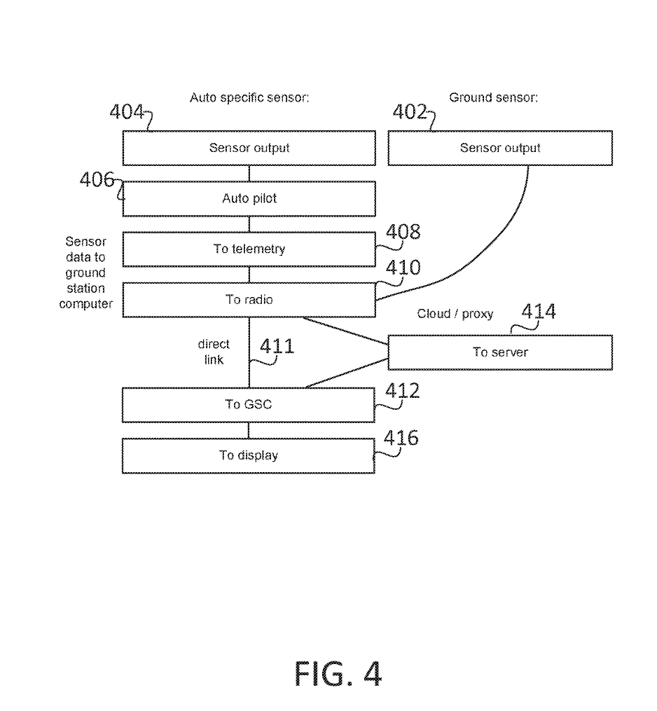

For example, if thermal sensor readings are above or below a predetermined threshold one possibility is for the UAV control system to send an alert to the ground station. This alert may then trigger the user to initiate a mission to further examine the temperature irregularity. Another possibility involves sensing a temperature signature, and then external processing, either onboard, in a cloud/server, or on a ground station is performed. Telemetry data is then sent to UAV control system which results in the system plotting a course to gather more detailed readings. FIG. 4 shows an example flow of data from the ground sensor 402 and the auto specific sensor 404. In FIG. 4, the data coming from the auto specific sensor output 404 may be sent to the auto pilot 406 which may then send it to the telemetry system 408 to a radio 410. The Ground Station Computer 412 may then receive the information by a ground link 411 or through the cloud server 414 for display at the ground station 416. If the ground sensor is used 402, that information may be sent right to the radio 410.

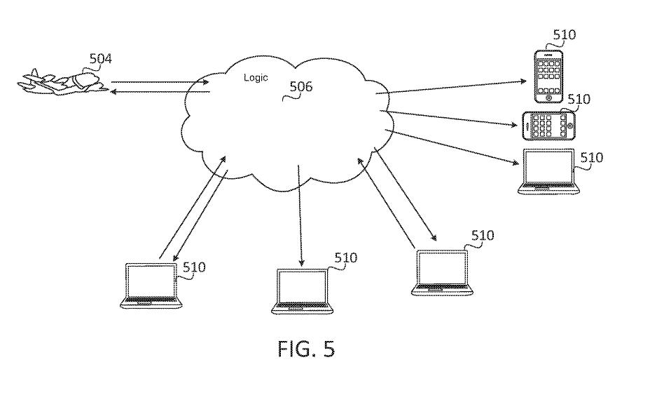

FIG. 5 shows an example networking diagram of the UAV 504 in communication with a network 506 and a multitude of computers 510. The computers 510 are not particularly limited and may be a mobile device such as e.g., a smartphone, PDA, a laptop, personal computer, tablet, or wearable computer etc. A desktop computer may be connected to the internet and provide a web interface for displaying a graphical user interface for controlling the drone 504.

Any number of servers may be used for the network connection 506 and the severs may include or be connected to a memory for storing computer instructions required to implement the method described herein and may store the various databases, user information and login/account verification algorithms. The server may be accessed over a wired and/or wireless network.

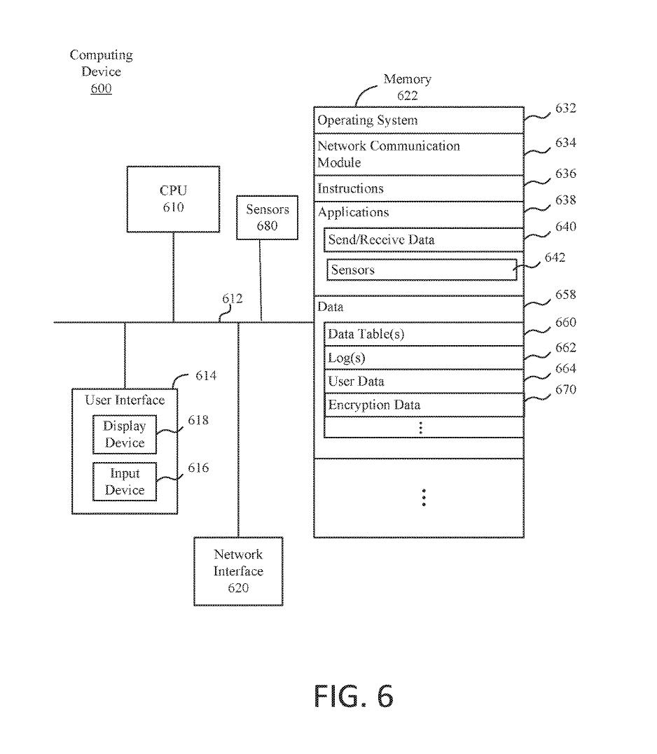

FIG. 6 shows example computer hardware which may be used in the onboard computers for the UAV, the servers which interact with the network, and ground stations. In FIG. 6, the computing device 600 includes a CPU 610 which communicates by a bus 612 with various computer components such as a user interface 614 including a display 618 and an input 616. This display may be only for a ground station computer, or for a UAV with such features added in. The computer system 600 also includes a network interface 620 which may include radios, antennae and other wireless networking components. The computer system 600 also includes a memory 622 which is used to execute an operating system 632 a network communication module 634 instructions 636 and applications 638. Example applications may be to send and receive data 640 and process sensor data 642. Data 658 may be stored in tables 660, logs 662, user data 664 may be stored and in some examples, encryption data.

Other peripherals such as sensors 680 of any various sorts described herein may be used.

The server and/or internet may allow a plurality of users to provide access to the drone. In some embodiments, a view mode is provided where non-operator users receive the data transmitted by the drone, but the non-operator users are prevented from transmitting data to the drone. Alternatively, a plurality of users may be control the drone, such as from a website.

It will be understood by those skilled in the art that central processing units (CPUs) can be included in the base unit controller, UAV, processing unit, autopilot, signal strength determining apparatus, thermal imaging sensor and location determining apparatus.

### CONCLUSION

Although the present embodiments have been described in terms of specific exemplary embodiments and examples, it will be appreciated that the embodiments disclosed herein are for illustrative purposes only and various modifications and alterations might be made by those skilled in the art without departing from the spirit and scope of the embodiments as set forth in the following claims.

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descriptions pertains that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a general-purpose processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. An unmanned aerial vehicle control system comprising:
a base unit controller; and
an unmanned aerial vehicle comprising:
a processing unit,
capable of switching between a point-to-point radio frequency connection and a cellular data network connection;
an autopilot; and
a signal strength determining apparatus configured for estimating the signal strength between the unmanned aerial vehicle and the base unit controller, and the signal strength between the unmanned aerial vehicle and the cellular data network.

2. The unmanned aerial vehicle control system of claim 1, wherein the control system uses the point-to-point radio frequency connection when the signal strength between the unmanned aerial vehicle and the base unit controller is at or below a predetermined signal strength.

3. The unmanned aerial vehicle control system of claim 1, wherein the control system uses the cellular data network connection when the signal strength between the unmanned aerial vehicle and the base unit controller is above a predetermined signal strength.

4. The unmanned aerial vehicle control system of claim 1, wherein the control system uses the point-to-point radio frequency connection when the signal strength between the unmanned aerial vehicle and the base unit controller is at or below a predetermined signal strength, and
wherein the control system uses the cellular data network connection when the signal strength between the unmanned aerial vehicle and the base unit controller is above a predetermined signal strength.

5. The unmanned aerial vehicle control system of claim 1, wherein the autopilot operates according to a set of predetermined behavior fail-safes when the unmanned aerial vehicle loses both the point-to-point radio frequency connection and the cellular data network connection.

6. The unmanned aerial vehicle control system of claim 5, wherein the set of predetermined behavior fail-safes consists of continue mission, return home, return to place of last known signal, continue to a network hotspot, go to a pre-determined location, loiter, circle, hover, land, lower altitude, follow geographic contours and combinations thereof.

7. The unmanned aerial vehicle control system of claim 1, wherein the base unit controller comprises a server and an apparatus selected from the group consisting of a smartphone, a personal digital assistant, a tablet, a laptop computer and a desktop computer.

8. The unmanned aerial vehicle control system of claim 1, wherein the cellular data network comprises 3G, 4G, Long Term Evolution (LTE), Code Division Multiple Access (CDMA), and/or Global System for Mobile communications (GSM) networks.

9. An unmanned aerial vehicle control system for fire detection comprising:
a base unit controller; and
an unmanned aerial vehicle comprising:
a processing unit;
an autopilot; and
a thermal imaging sensor,
wherein the base unit controller and unmanned aerial vehicle connect with each other using a cellular data network connection, and wherein the thermal imaging sensor is configured for detecting fire.

10. The unmanned aerial vehicle control system of claim 9, wherein the base unit controller comprises a server and an apparatus selected from the group consisting of a smartphone, a personal digital assistant, a tablet, a laptop computer and a desktop computer.

11. The unmanned aerial vehicle control system of claim 9, wherein the cellular data network comprises 3G, 4G, Long Term Evolution (LTE), Code Division Multiple Access (CDMA), and/or Global System for Mobile communications (GSM) networks.

12. An unmanned aerial vehicle control system for maximizing cellular data network coverage comprising:
a base unit controller; and
an unmanned aerial vehicle comprising:
a processing unit;
an autopilot configured for storing and utilizing and accessing cellular data network coverage maps; and
a location determining apparatus for estimating the distance and position of the unmanned aerial vehicle from the nearest point on a cellular data network coverage map.

13. The unmanned aerial vehicle control system of claim 12, wherein the unmanned aerial vehicle control system flies to a predetermined or real-time processed destination using the shortest distance that comprises points on the cellular data network coverage map.

14. The unmanned aerial vehicle control system of claim 12, wherein the cellular data network coverage maps comprise 3G and/or 4G maps.

15. The unmanned aerial vehicle control system of claim 14, wherein the 3G and/or 4G maps are publicly accessible maps from AT&T, Verizon, Sprint and/or T-Mobile.

16. The unmanned aerial vehicle control system of claim 12, wherein the autopilot operates according to a set of predetermined behavior fail-safes when the unmanned aerial vehicle is outside of the cellular data network coverage maps.

17. The unmanned aerial vehicle control system of claim 16, wherein the set of predetermined behavior fail-safes consists of continue mission, return home, return to place of last known signal, continue to a network hotspot, go to a pre-determined location, loiter, circle, hover, land, lower altitude, ascend, follow geographic contours or other sensor data, and combinations thereof.

18. The unmanned aerial vehicle control system of claim 12, wherein the base unit controller comprises a server and an apparatus selected from the group consisting of smartphone, a personal digital assistant, a tablet, a laptop computer and a desktop computer.
